(19) United States
(12) Patent Application Publication
(10) Pub. No.: US 2013/0300062 A1
(43) Pub. Date: Nov. 14, 2013

(54) Card Game

(71) Applicant: Ryan Moore, Hamilton (CA)

(72) Inventor: Ryan Moore, Hamilton (CA)

(21) Appl. No.: 13/837,354

(22) Filed: Mar. 15, 2013

Related U.S. Application Data
(63) Continuation-in-part of application No. 13/470,248, filed on May 11, 2012.

(51) Int. Cl. G07F 17/32

(52) U.S. Cl. CPC G07F 17/3293
USPC 273/292; 463/11

(57) ABSTRACT

A card game with at least one player comprises receiving at least one draw card bet predicting at least one of suit, denomination, color and card identity of a draw card, drawing a first card from the plurality of cards as the draw card, and evaluating each draw card bet by comparing each draw card bet to the draw card. The card game may further comprise receiving, either before or after drawing the draw card, at least one chaser bet predicting a denomination range for at least one of a set of chaser cards and, after drawing the draw card, drawing a set of cards from the plurality of cards as the chaser cards and evaluating each chaser bet by comparing each chaser bet to the chaser cards. The card game may be played with physical cards or via a computer simulation, and may be played over the Internet.

### CROSS-REFERENCE TO RELATED APPLICATIONS

The present application is a continuation-in-part of U.S. application Ser. No. 13/470,246, filed on May 11, 2012, now pending, the disclosure of which is incorporated herein by reference.

### FIELD OF THE INVENTION

The present disclosure relates to card games, particularly table card games and computer-implemented card games, including internet card games.

### BACKGROUND OF THE INVENTION

Card games have become ubiquitous throughout society. People play card games for entertainment, and professionally. Various card games have been developed in the past, such as blackjack, poker, or baccarat. These types of card games, in which the player attempts to approach a predetermined value or collect cards with particular suits or denominations, rely on the player's ability to accurately and quickly determine a winning or losing hand. Some card games have complex rules and are difficult for inexperienced players. To compound the problem, some games are played at an extremely fast pace, especially at a professional or casino level. Thus, it can be difficult and perhaps uninviting to a novice player to keep up with the pace of a complex game.

Accordingly, there is a need for a card game that can be easily and successfully played with only basic knowledge of the rules, without sacrificing the speed of play.

### BRIEF SUMMARY OF THE INVENTION

The card game described in the present disclosure may provide an easy-to-comprehend playing surface, either physical or computer-implemented, and the game may provide the player(s) with a selection of bets that are easy to comprehend for an inexperienced player. Furthermore, the pace of game play can be governed by the operator. Therefore, in a physical embodiment a variety of tables could host varying degrees of game play pace. The ability to vary the pace of play adds value to the player experience and to the operator's revenue stream. Player experience may also be enhanced by allowing multiple players to gather around a physical playing surface, adding the element of community to the game. In addition, the invention can, where permitted by law, provide a level of profitability similar to the levels that an operator of a table game would expect in a casino setting. The game can also be played using a computer, either directly or over a computer network such as the Internet.

A method of playing a card game with at least one player comprises receiving at least one draw card bet from at least one of the at least one player, with each draw card bet predicting at least one of suit, denomination, color and card identity of a draw card, drawing a first card from the plurality of cards as the draw card and then evaluating each draw card bet by comparing each draw card bet to the draw card. The method may include crediting the successful player where the draw card bet is successful.

Predicting denomination of the draw card may comprise predicting a denomination range of the draw card, and in one embodiment comprises predicting that the denomination of the draw card will fall within one of (a) a range between and including two and seven, and (b) a range between and including nine and Ace.

The method may further comprise receiving at least one chaser bet from at least one of the at least one player, with each chaser bet predicting a denomination range for at least one of a set of chaser cards, and, after drawing the first card from the plurality of cards as the draw card, drawing a set of cards from the plurality of cards as the chaser cards and then evaluating each chaser bet by comparing each chaser bet to the chaser cards. In one embodiment, the chaser bet is received before drawing the first card from the plurality of cards as the draw card. In such an embodiment, the chaser bet may further predict a denomination range for the draw card. Alternatively, the chaser bet may be received after drawing the first card from the plurality of cards as the draw card, and only responsive to the draw card meeting at least one predetermined criterion for availability of the chaser bet. In a particular embodiment, the chaser bet predicts that at least one of the chaser cards will have a denomination in the range Jack, Queen, King, Ace. Evaluating each chaser bet by comparing each chaser bet to the chaser cards may comprise considering the order in which the chaser cards were drawn. In one embodiment, there are three chaser cards.

In an embodiment in which the card game is played with physical cards, the draw card and chaser cards are physically drawn from the plurality of cards. Other embodiments include computer-implemented methods for playing the card game, data processing systems configured for playing computer-implemented embodiments of the card game, and computer-program products for implementing the card game. In computer-implemented embodiments, the cards are simulated, and at least an indication of a simulated draw card and of simulated chaser cards can be communicated by displaying an image of the card(s) on a computer display.

In one computer-implemented embodiment, the card game is played directly on a local computer system, such as a desktop computer, laptop computer, smartphone or tablet computer. In another computer-implemented embodiment, the card game is played using a gaming server, the at least one draw card bet (and any chaser bets) are received from at least one computing device remote from and communicating with the gaming server, and at least an indication of the draw card can be communicated from the game server to the remote computing device(s). The remote computing device(s) may be, for example, desktop computers, laptop computers, smartphones and tablet computers. The gaming server and the remote computing device(s) may communicate with one another over the Internet.

### DESCRIPTION OF THE DRAWINGS

For a fuller understanding of the nature and objects of the invention, reference should be made to the following detailed description taken in conjunction with the accompanying drawings, in which:

FIG. 1 is a flow chart showing a first exemplary method for a card game as described herein;

FIG. 1A is a flow chart showing a second exemplary method for a card game as described herein

FIG. 1B is a flow chart showing a third exemplary method for a card game as described herein;

FIG. 1C is a flow chart showing a fourth exemplary method for a card game as described herein;

FIG. 1D is a flow chart showing a fifth exemplary method for a card game as described herein;

FIG. 2 is a diagram of an exemplary playing surface that may be used in association with a card game as described herein;

FIG. 3A shows the playing surface of FIG. 2 after completion of a first exemplary round of a card game as described herein;

FIG. 3B shows the playing surface of FIG. 2 after completion of a second exemplary round of a card game as described herein;

FIG. 4 is a diagram of a generic data processing system for a computer-implemented embodiment of a card game as described herein;

FIG. 5 is a diagram of a system for a computer-implemented embodiment of a card game as described herein to be played over the Internet;

FIG. 6 is a block diagram showing an exemplary computer system which may be used with computer-implemented embodiments of a card game as described herein; and

FIG. 7 is a block diagram showing an exemplary networked mobile wireless telecommunication computing device which may be used with computer-implemented embodiments of a card game as described herein.

Other features of the invention can be found in the following description, the enclosed claims and/or the attached drawings.

### DETAILED DESCRIPTION OF THE INVENTION

The present disclosure describes a new card game and playing surface. Although the new card game may be played with standard playing cards, it is believed to represent a significant contribution or addition to the cumulative wisdom on the subject of games. Moreover, the game described herein has a practical application as it involves either the physical manipulation of cards or the simulation thereof by a computer and hence the manifestation of a discernible effect or change. In addition, by providing a card game that can, where permitted by law, be played in physical or online casinos, and which may be provided as a computer-implemented embodiment in exchange for consideration, the card game described herein provides a result that is commercially useful.

The game may involve a single player or multiple players. In one embodiment, the game is played with at least one player, but preferably no more than eight simultaneous players where the game is played physically rather than in a computer-implemented way. Generally, a player is a human being, although in some embodiments, a player may be a computer-simulated player. A computer-simulated player may be programmed to exhibit certain personalities. For example, a computer-simulated player may have a cautious (i.e., risk averse) style of playing the card game. In another example, a computer-simulated player may have an aggressive (i.e., high risk, high reward) style of playing the card game.

In one embodiment, the player(s) “buy-in” to the table and may be subsequently provided markers by the House equivalent to the value of the buy-in. Throughout the specification, the term “House” refers to the operator facilitating the card game. For example, the House may be a human person, a business entity, or a computer. In some embodiments, the player(s) buys-in using legal tender (where permitted by law). In other embodiments, the player(s) may be given an arbitrary buy-in by the House. The buy-in does not need to be related to legal tender. For example, in one embodiment, the House provides each player with 50 markers as a buy-in. The player(s) then use these markers during game play. The markers may be any suitable marker used to track bets announced by players. For example, the markers may be colored chips that assist the House in tracking bets made by the player(s). The markers may be purely electronic and expressed through software.

The game is played with a plurality of cards, each card having a suit, denomination, and color. For example, the plurality of cards may be a standard 52-card deck containing four suits (diamonds, hearts, spades, and clubs), each suit having 13 cards (2 to 10, Jack, Queen, King and Ace). Two suits (diamonds and hearts) are red, and the other two suits (spades and clubs) are black. In another example, the plurality of cards may be multiple standard 52-card decks. In a further example, the plurality of cards may comprise “n” cards, the cards having “m” suits, “x” denominations, and “z” colors, where n, m, x, and z are all positive integers. Thus, cards other than standard playing cards may optionally be used.

Generally, the players will make one or more bets on the outcome of one or more cards drawn from the plurality of cards. A “bet”, as that term is used herein comprises a prediction of an outcome and may further comprise a bet magnitude associated with the prediction. For example, a player may announce a bet of $15 on the first drawn card being red. Here, the predicted outcome is the color of the first drawn card (red) and the bet magnitude is $15. In one embodiment, a bet may be announced verbally. In another embodiment, a bet may be announced by placing a marker onto a playing surface table. In another embodiment, the player(s) may announce bets electronically through an input device, such as a keyboard or touch screen. The input device may be part of a networked laptop, or a networked mobile wireless telecommunication device, such as a mobile phone or tablet computer, as described in greater detail below.

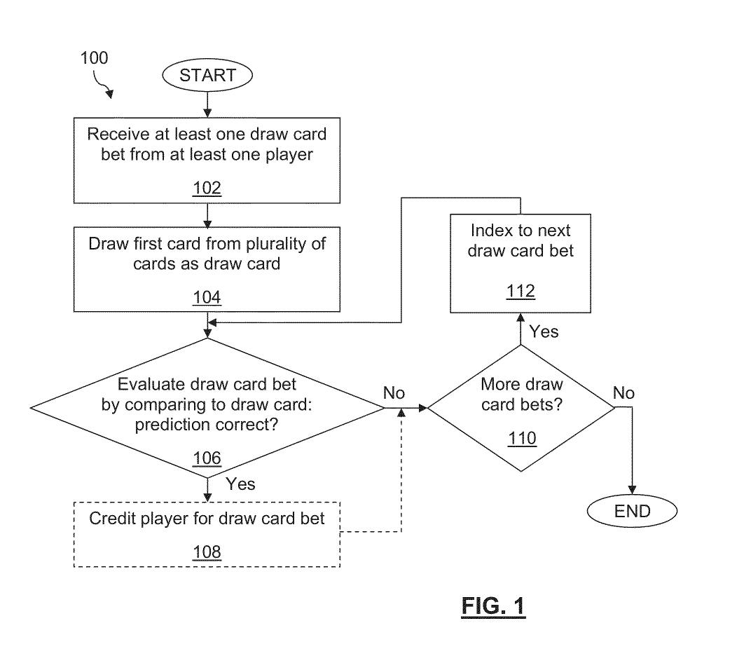

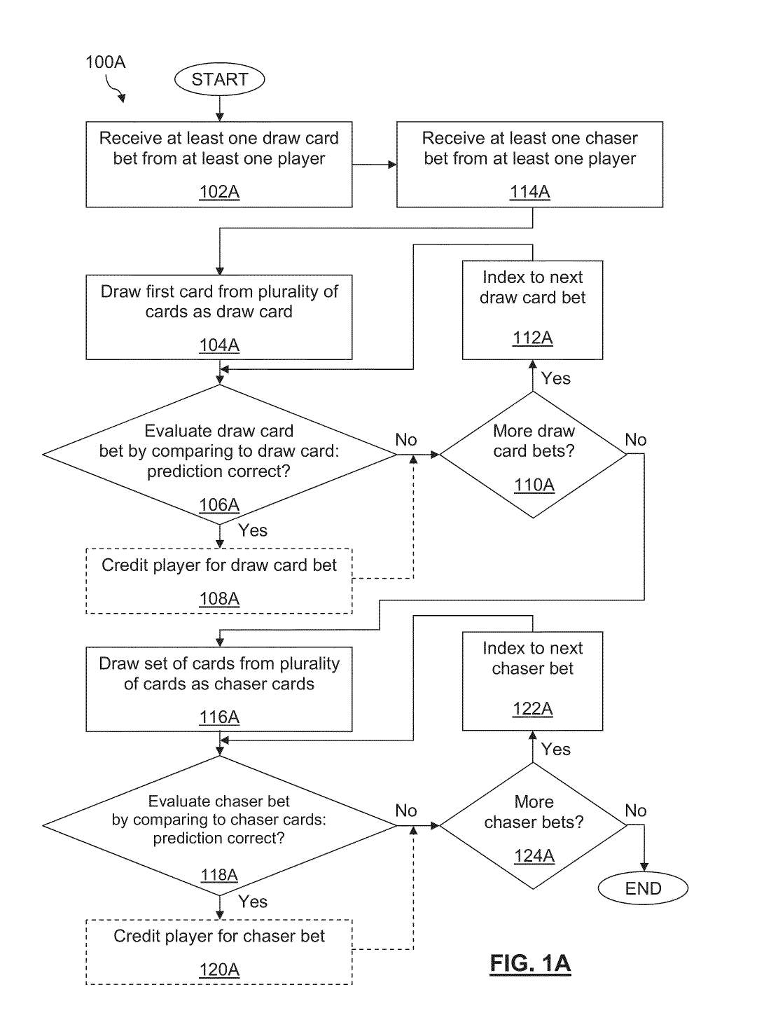

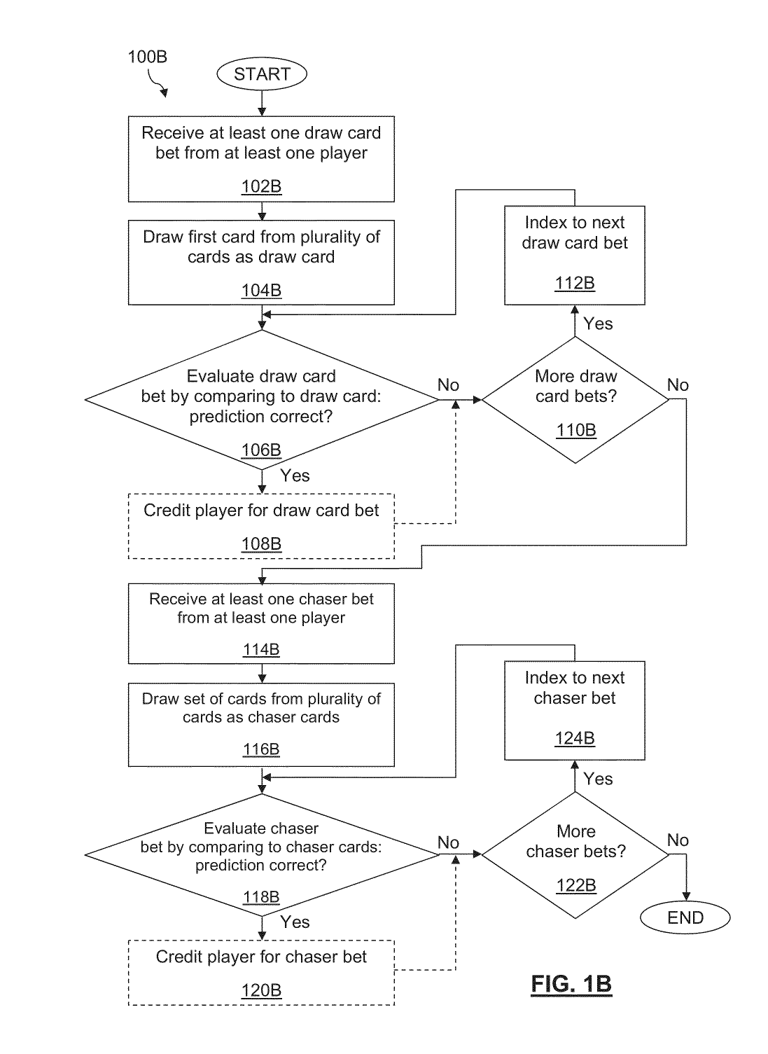

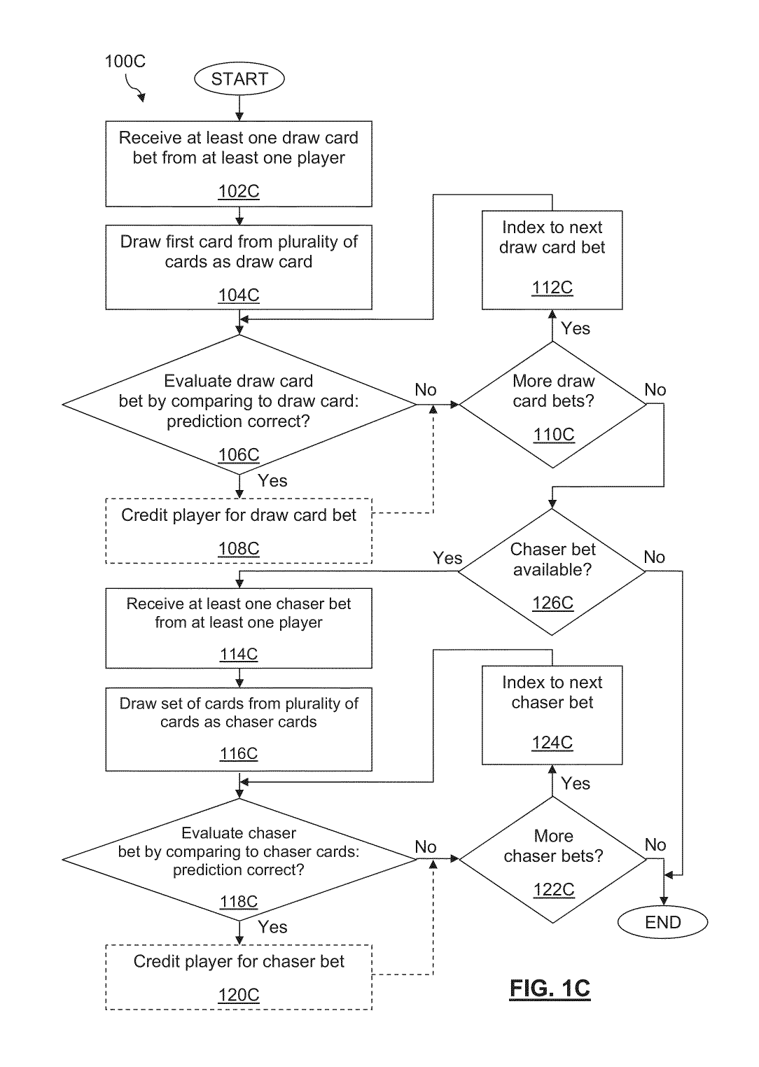

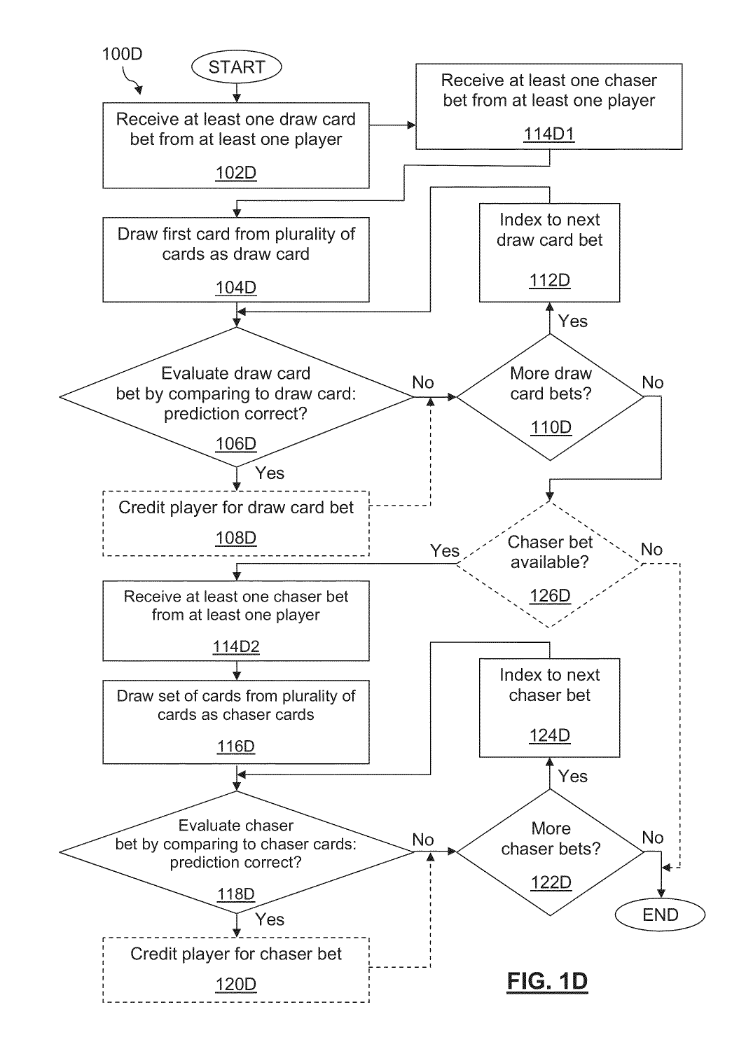

Reference is now made to FIG. 1, which is a flow chart showing a first exemplary method 100 for playing one round of the card game. The method 100, as well as the methods 100A, 100B and 100C discussed below, may be implemented in a physical embodiment in which physical cards are used, or by way of a computer-implemented embodiment in which the cards are simulated.

At step 102, the method 100 receives at least one draw card bet from at least one player. If there are multiple players, some players may opt not to provide a draw card bet during a particular round as long as at least one player provides a draw card bet. Each draw card bet received at step 102 predicts at least one of suit, denomination, color and card identity of a “draw card” (defined below). For example, where standard playing cards are used, a draw card bet may predict suit (diamonds, hearts, spades, or clubs), color (red or black), denomination (Ace, 2-10, Jack, Queen, and King), a combination of color and denomination (e.g. “red 3” or “black Queen”), or card identity (e.g. “5 of diamonds” or “7 of spades”). In a preferred embodiment, predicting the denomination of the draw card may include the option of predicting either a precise denomination or a denomination range of the draw card. For example, in a preferred embodiment the draw card bet may predict that the draw card will have a denomination in a “low” range consisting of the denominations 2, 3, 4, 5, 6 and 7 or a “high” range consisting of the denominations 9, 10, Jack, Queen, King, Ace. In this preferred embodiment, the denomination ranges on which a draw card bet can be placed do not include the number 8 because by removing the number 8, the odds become more favorable to the House. Optionally, Jokers may be included among the cards, in which case a draw card bet could predict the card identity “Joker”, as a Joker does not have a suit or color.

At step 104, after receiving the draw card bet, a first card is drawn from the plurality of cards; this first drawn card is the “draw card”. The draw card may be drawn by hand by a dealer, mechanically using an automatic card dispensing device, or through a computer-simulated plurality of cards. The draw card may or may not be immediately shown to the player(s).

At step 106, a draw card bet is evaluated by comparing a draw card bet to the draw card, and, at optional step 108, responsive to evaluating a draw card bet as successful, the method 100 credits the player who made that draw card bet. Steps 110 and 112 respectively check to see if there are additional draw card bets to evaluate and, if so, index to the next draw card bet and return to step 106 if there are more draw card bets to evaluate. If the method 100 determines at step 110 that all draw card bets were evaluated, the method 100 ends. Although the draw card bets are shown as being evaluated sequentially, they may in practice be evaluated substantially simultaneously. Once all of the draw card bets have been evaluated and the successful players credited, the method ends.

A draw card bet is successful if the prediction made by that draw card bet is correct. In embodiments where the draw card bet has a magnitude, the House will typically credit the player an amount proportional to the magnitude of the draw card bet. The ratio of the credit may vary. For example, the ratio of the credit may be proportional, or otherwise related, to the probability of the prediction of the draw card bet being correct. For example, the ratio may be low if the draw card bet predicts the color of the draw card and the ratio may be high if the draw card bet predicts the identity of the draw card. If a player's draw card bet is unsuccessful, i.e. the prediction is inaccurate, the House collects the bet magnitude. A player with a successful draw card bet may, where permitted by law, be credited with legal tender or with markers such as chips that are redeemable for legal tender. Alternatively, the player may be credited in a manner unrelated to legal tender, for example by way of points whose only value is for the purpose of comparing performance to other players.

In certain preferred embodiments, the game provides for receiving one or more “chaser bets” from the player(s). A chaser bet is a prediction about at least one card in a set of “chaser cards” that are drawn after the draw card is drawn, and may be independent of the draw card or may include a prediction about the draw card. In a presently preferred embodiment, a set of three cards is used as the chaser cards, although fewer than three cards or more than three cards may be used. Also in a preferred embodiment, each chaser bet predicts that at least one of the chaser cards will have a denomination falling within a specified range. In a particularly preferred embodiment, each chaser bet predicts that at least one of the chaser cards will have a denomination in the range of Jack, Queen, King, Ace, as explained further below. In other embodiments, a chaser bet may predict the color, suits, specific denomination or identity of one or more of the chaser cards. The chaser bet may be sensitive or insensitive to the order in which the chaser cards are drawn. The chaser bets can be received either before or after drawing the draw card; where the chaser bet is received before the draw card is drawn it will preferably make a prediction about the draw card and at least one of the chaser cards. In a particular embodiment, the chaser bet may predict a denomination range for the group of cards comprising the draw card and one or more of the chaser cards; in other embodiments a chaser bet may predict that the draw card and at least one of the chaser cards will all be the same color, the same suit, the same denomination or of different colors, suits or denominations.

For example, where the chaser bet is received before the draw card is drawn, the chaser bet may predict that the draw card and at least “y” of the draw cards will have a denomination of Jack, Queen, King or Ace, where y is a positive integer less than or equal to the number of chaser cards. If the chaser bet is order sensitive, it may predict that the draw card and the first y draw cards will have a denomination of Jack, Queen, King or Ace; if the chaser bet is order insensitive, it may predict that the draw card and any y of the chaser cards will have a denomination of Jack, Queen, King or Ace. Where a chaser bet predicts that all of the chaser cards will fall within the denomination range, the order in which the chaser cards are drawn is immaterial. In a particularly preferred embodiment, the player making the chaser bet can choose the value of y, up to and including the total number of chaser cards. For example, where there are three chaser cards and the chaser bet is order sensitive, a player may place a chaser bet comprising a prediction selected from the group consisting of (a) the draw card and the first chaser card will have a denomination of Jack, Queen, King or Ace, (b) the draw card and the first two chaser cards will have a denomination of Jack, Queen, King or Ace; and (c) the draw card and all three chaser cards will have a denomination of Jack, Queen, King or Ace. In this example, chaser bet (a) or (b) would win if the draw card was a Queen, the first chaser card was an Ace, the second chaser card was a Jack and the third chaser card was a 7, but would lose if the draw card was a Queen, the first chaser card was a 7, the second chaser card was an Ace and the third chaser card was a Jack. In a case where there are three chaser cards and the chaser bet is order insensitive, a player may place a chaser bet comprising a prediction selected from the group consisting of (a) the draw card and any one of the chaser cards will have a denomination of Jack, Queen, King or Ace, (b) the draw card and any two of the chaser cards will have a denomination of Jack, Queen, King or Ace; and (c) the draw card and all three chaser cards will have a denomination of Jack, Queen, King or Ace. In this example, chaser bet (a) or (b) would win if the draw card was a Queen, the first chaser card was an Ace, the second chaser card was a Jack and the third chaser card was a 7 and would also win if the draw card was a Queen, the first chaser card was a 7, the second chaser card was an Ace and the third chaser card was a Jack.

FIG. 1A shows an exemplary method 100A which is similar to the method 100 except that it provides for chaser bets to be received, in addition or as an alternative to draw card bets, before the draw card is drawn. As such, corresponding reference numerals are used to refer to corresponding steps, except with the suffix “A”.

In the exemplary method 100A shown in FIG. 100A, at step 114A the method 100A receives at least one chaser bet from at least one player after, or substantially simultaneously with, receipt of at least one draw card bet at step 102A. The chaser bet(s) are received at step 114A before drawing the first card as the draw card at step 104A. Each chaser bet may predict a denomination range for the draw card as well as a denomination range for at least one of the chaser cards. Steps 102A and 114A may be performed in any order or substantially simultaneously.

After drawing the first card from the plurality of cards as the draw card at step 104A and evaluating all of the draw card bets at steps 106A through 112A, the method 100A proceeds to step 116A. At step 116A a set of cards is drawn from the plurality of cards; the cards in this set are the “chaser cards”. Like the draw card, the chaser cards may be drawn by hand by a dealer, mechanically using an automatic card dispensing device, or through a computer-simulated plurality of cards. At step 118A, the method 100A evaluates a chaser bet by comparing the chaser bet to the chaser cards (and the draw card where the chaser bet includes a prediction about the draw card), and at step 120A, responsive to evaluating a chaser bet as successful, the method 100A credits the player who made that chaser bet. Analogously to the evaluation of the draw card bets, steps 122A and 124A respectively check to see if there are additional chaser bets to evaluate and, if so, index to the next chaser bet and return to step 118A if there are more chaser bets to evaluate. If the method 100 determines at step 122A that all chaser bets were evaluated, the method 100A ends. Although the chaser bets are shown as being evaluated sequentially, they may in practice be evaluated substantially simultaneously. In addition, in alternate embodiments chaser bets may be evaluated before, or substantially simultaneously with evaluation of the draw card bets. A chaser bet is successful if the prediction of that chaser bet is correct. Also analogously to the procedure described above for draw card bets, in embodiments where the chaser bet has a magnitude, the House will typically credit the player an amount proportional or otherwise related to the magnitude of the chaser bet, usually dependent on the odds of the chaser bet prediction being accurate.

In some embodiments, chaser bets may be received after the draw card is drawn. Analogously to the case where chaser bets are received before the draw card is drawn, in cases where chaser bets are received after the draw card is drawn, the chaser bets may predict that at least y of the chaser cards will have a denomination of Jack, Queen, King or Ace, with y being a positive integer that is less than or equal to the number of chaser cards. The chaser bet may be order sensitive or order insensitive, and the player making the chaser bet may be permitted to choose the value of y, up to and including the total number of chaser cards. For example, where there are three chaser cards and the chaser bet is order sensitive, a player may place a chaser bet comprising a prediction selected from the group consisting of (a) the first chaser card will have a denomination of Jack, Queen, King or Ace, (b) the first two chaser cards will have a denomination of Jack, Queen, King or Ace; and (c) all three chaser cards will have a denomination of Jack, Queen, King or Ace. Where there are three chaser cards and the chaser bet is order insensitive, a player may place a chaser bet comprising a prediction selected from the group consisting of (a) any one of the chaser cards will have a denomination of Jack, Queen, King or Ace, (b) any two of the chaser cards will have a denomination of Jack, Queen, King or Ace; and (c) all three chaser cards will have a denomination of Jack, Queen, King or Ace.

FIG. 1B shows an exemplary method 100B which is similar to the method 100A except that it provides for chaser bets to be received, in addition or as an alternative to draw card bets, after the draw card is drawn. As such, corresponding reference numerals are used to refer to corresponding steps, except with the suffix “B” instead of “A”. In the exemplary method 100B, the chaser bets are independent of the identity of the draw card. The method 100B receives at least one chaser bet from at least one player at step 114B after drawing the first card as the draw card at step 104B, rather than before. Although FIG. 1B shows step 114B of receiving at least one chaser bet as occurring after step 106B, step 114B may occur at any time after step 104B and before step 116B.

Where the chaser bet is received after the draw card is drawn, the option of placing a chaser bet may be made available in all cases, as shown in FIG. 1B, or only where the draw card meets one or more predefined criteria for availability of the chaser bet. In a preferred embodiment, chaser bets are only received if the draw card has a denomination corresponding to an available prediction for the chaser bet. Thus, in one embodiment, the chaser bet may predict that one or more of the chaser cards will fall within a specified denomination range, and chaser bets would only be permitted if the draw card also falls within the specified denomination range. For example, where a chaser bet predicts that one or more chaser cards will have a denomination of Jack, Queen, King or Ace, chaser bets would only be made and received where the draw card was a Jack, Queen, King or Ace.

FIG. 1C shows an exemplary method 100C which is similar to the method 100B, with corresponding reference numerals used to refer to corresponding steps but with the suffix “C” instead of “B”. The exemplary method 100C in FIG. 1C differs from the exemplary method 100B in FIG. 1B in that chaser bets are received at step 114C only responsive to a determination at step 126C that the draw card meets at least one predetermined criterion for availability of the chaser bet.

FIG. 1D shows an exemplary method 100D which is similar to the methods 100A, 100B and 100C except that it provides for chaser bets to be received both before (step 114D1), and after (step 114D2) the draw card is drawn at step 104D. Corresponding reference numerals refer to corresponding steps but with the suffix “D” instead of “A”, “B” or “C”. In one embodiment, chaser bets are only received at step 114D2 (after the draw card is drawn at step 104D) if the method 100D determines at optional step 126D that the draw card meets at least one predetermined criterion for availability of the chaser bet. Where the chaser bet is independent of the draw card, optional step 126D may be omitted. The amount credited to a player at step 120D for a successful chaser bet may follow different formulas depending on whether a chaser bet is received before or after the draw card is drawn at step 104D.

Each of FIGS. 1, 1A, 1B, 1C and 1D represent a “round”, and the game may be played over any indefinite number of rounds. Players may enter and exit (i.e., begin or stop playing) the game at the beginning of each round. Drawn cards may be returned to the plurality of cards at the end of each round, or may be removed from the plurality of cards for a predetermined number of rounds.

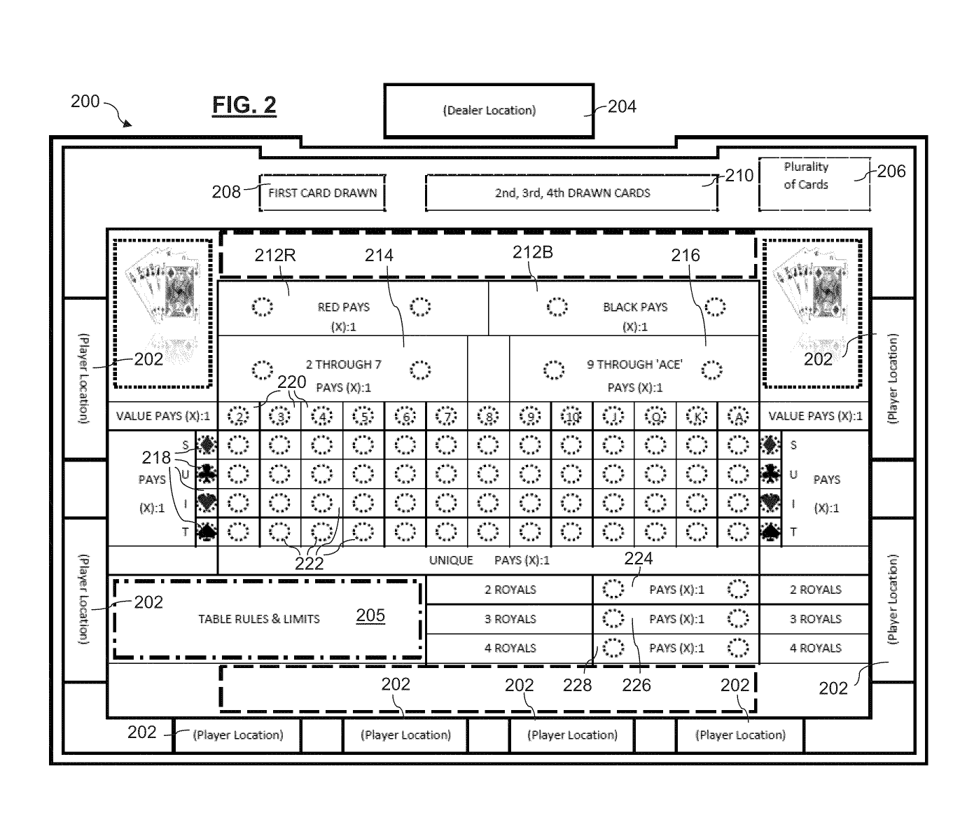

In one embodiment, draw card bets and/or chaser bets may be announced by a player, and received by the House, using a playing surface such as a table. FIG. 2 depicts one exemplary embodiment of a playing surface 200 which includes a plurality of player locations 202 where players can put unused markers. A dealer location 204 is provided adjacent the playing surface 200. The playing surface 200 also includes locations 206, 208 and 210 near the dealer location 204 for placing the plurality of cards, the draw card and the chaser cards, respectively. A location 205 for displaying the rules and bet limits is also provided on the playing surface 200. In a physical embodiment, the locations 202, 205, 206, 208 and 210 are formed by markings on the playing surface 200.

The exemplary playing surface 200 has bet regions indicating specific bets, and bets can be announced by a player and received by the House by way of a player placing markers such as denominated chips on one or more particular bet regions. The bet regions may also be formed by markings on the playing surface 200. In this embodiment, the table includes red and black draw card color bet regions 212R, 212B, respectively, for draw cards bets predicting the color of the draw card, a draw card low range bet region 214 and draw card high range bet region 216 for predicting a range of the draw card, four draw card suit bet regions 218 for draw cards bets predicting the suit of the draw card, thirteen draw card denomination bet regions 220 for draw cards bets predicting the denomination of the draw card, and fifty-two draw card identity bet regions 222 for draw card bets predicting the identity of the draw card. In the exemplary playing surface 200, each of the draw card identity bet regions 222 is a cell in a grid formed by the positioning of the draw card suit bet regions 218 and the draw card denomination bet regions 220, with the draw card suit bet regions 218 defining the rows and the draw card denomination bet regions 220 defining the columns.

The bet regions on the exemplary playing surface 200 also include three chaser bet regions, namely a two-card royal prediction region 224, a three-card royal prediction region 226 and a four-card royal prediction region 228. The chaser bet regions 224, 226 and 228 may be used where there are three chaser cards, and may allow the announcement by a player and receiving by the House of chaser bets predicting the denomination of the draw card and at least one chaser card. In an embodiment where the chaser bets include a prediction about the draw card, the two-card royal prediction region 224 is for chaser bets predicting that the draw card and one of the chaser cards will have a denomination of Jack, Queen, King or Ace, the three-card royal prediction region 226 is for chaser bets predicting that the draw card and two of the chaser cards will have a denomination of Jack, Queen, King or Ace, and the four-card royal prediction region 228 is for chaser bets predicting that the draw card and all three chaser cards will have a denomination of Jack, Queen, King or Ace. The chaser bet regions 224, 226 and 228 can be used regardless of whether the chaser bet is order sensitive or order insensitive.

The exemplary playing surface 200 has been described by way of a physical implementation, such as the surface of a table in a casino. A virtual playing surface of the type shown in FIG. 2 may be presented on a computer display in a computer-implemented embodiment of a card game as described herein, and players may place bets by using, for example, a pointing device or a touch screen.

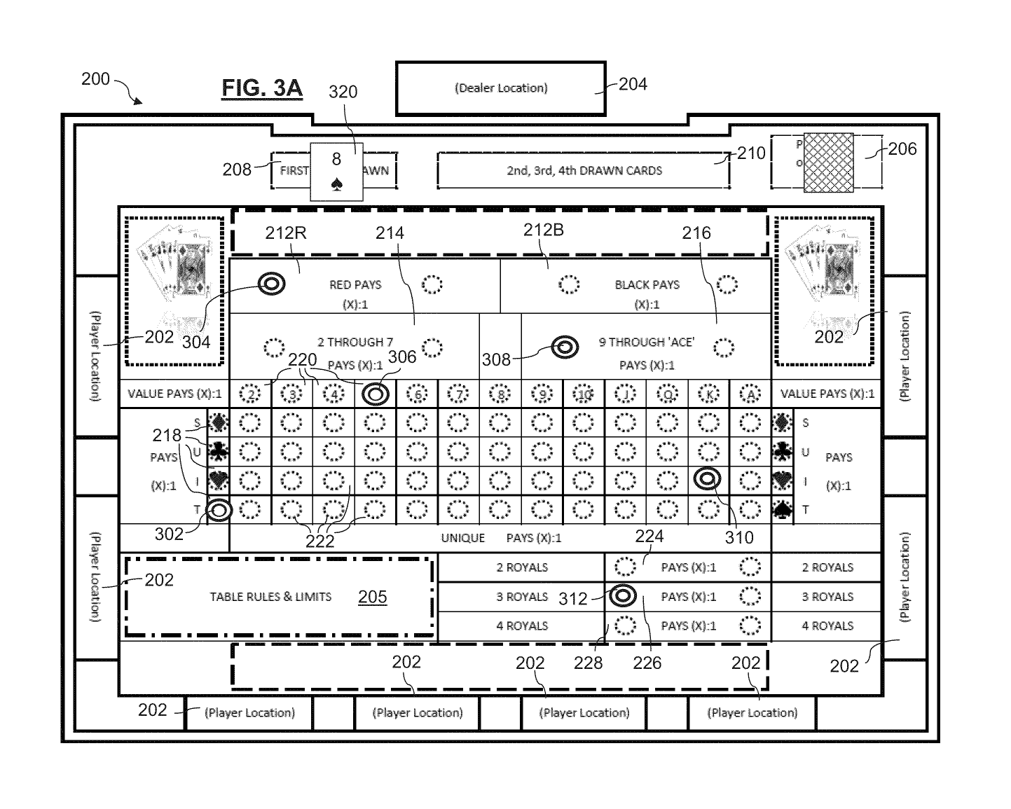

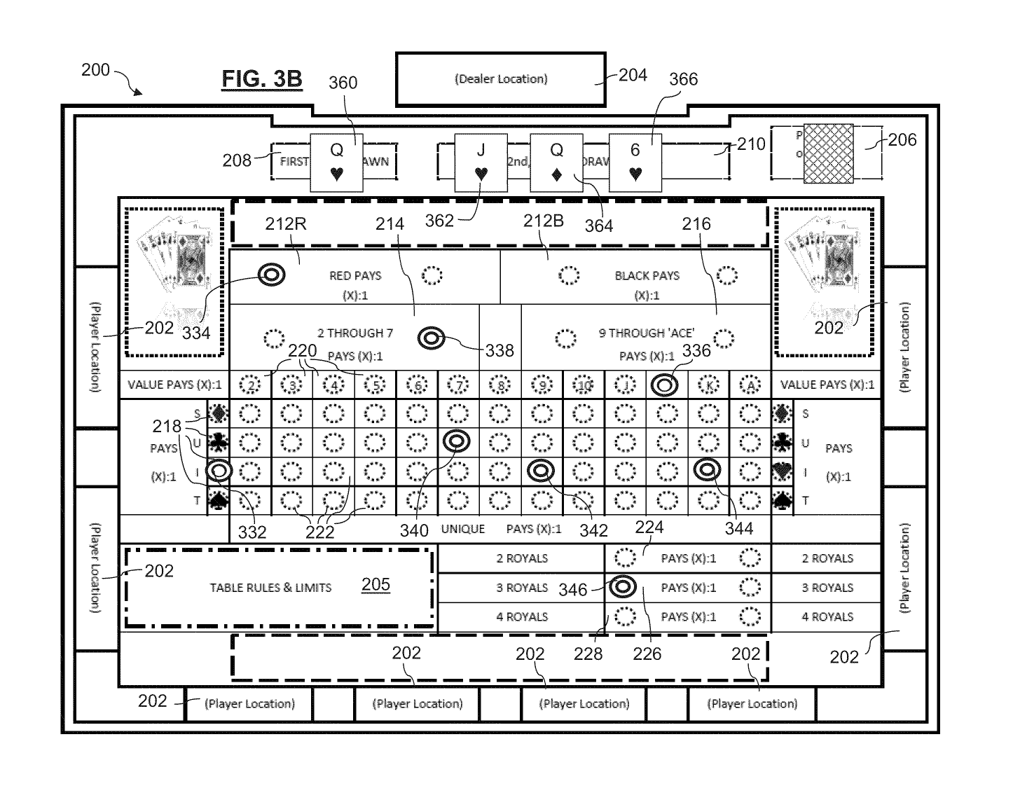

Reference is now made to FIG. 3A, which shows the completed play of a first exemplary round on the exemplary playing surface 200 according to the method 100A in FIG. 1A, in which the number of chaser cards is three, any chaser bets were received before the draw card is drawn and any chaser bets are order sensitive.

Before the draw card was drawn, several draw card bets were announced and received. A draw card bet predicting the suit of the draw card as being “spades” was made by placing a chip 302 on the corresponding draw card suit bet region 218, a draw card bet predicting the color of the draw card as “red” was made by placing a chip 304 on the red draw card color bet region 212R, and a draw card bet predicting the denomination of the draw card as “5” was made by placing a chip 306 on the corresponding draw card denomination bet region 220. A draw card bet predicting that the denomination of the draw card will be in the range of 9 through Ace was made by placing a chip 308 on the draw card high range bet region 216, and a draw card bet predicting the identity of the draw card as the “King of hearts” was made by placing a chip 310 on the corresponding draw card identity bet region 222. In addition, one chaser bet, predicting that the draw card and the first two chaser cards will have a denomination of Jack, Queen, King or Ace, was made by placing a chip 312 on the three-card royal prediction region 226.

After all of the bets were received, the draw card 320 was drawn, and, as can be seen in FIG. 3A, the draw card in this exemplary round is the “8 of spades”. Each of the draw card bets is then compared to the draw card 320. Based on this comparison, the draw card bet predicting the suit of the draw card as being “spades” (chip 302) was correct, and the player who placed that bet will be credited by being given additional chips according to the applicable ratio. However, the draw card bet predicting the color of the draw card as “red” (chip 304), the draw card bet predicting the denomination of the draw card as “five” (chip 306), the draw card bet predicting that the denomination of the draw card would be in the range of 9 through Ace (chip 308) and the draw card bet predicting the identity of the draw card as the “King of hearts” (chip 310) were all incorrect, and therefore the players who made those bets will not be credited for those bets. Instead, the chips associated with those bets are forfeited to the House. Since the chaser bet predicted that the draw card and the first two chaser cards would have a denomination of Jack, Queen, King or Ace (chip 312) and the draw card did not have a denomination of Jack, Queen, King or Ace, the drawing of the draw card determines that the chaser bet was incorrect, and it is not necessary to draw the chaser cards.

Reference is now made to FIG. 3B, which shows the completed play of a second exemplary round on the exemplary playing surface 200 according to the method 100A in FIG. 1A. Again, there were three chaser cards, chaser bets were received before the draw card is drawn and the chaser bets are order sensitive.

Again, prior to drawing the draw card, several draw card bets were announced and received. A draw card bet predicting the suit of the draw card as being “hearts” was made by placing a chip 332 on the corresponding draw card suit bet region 218, a draw card bet predicting the color of the draw card as “red” was made by placing a chip 334 on the red draw card color bet region 212R, and a draw card bet predicting the denomination of the draw card as “Queen” was made by placing a chip 336 on the corresponding draw card denomination bet region 220. A draw card bet predicting that the denomination of the draw card will be in the “low” range of 2 through 7 was made by placing a chip 338 on the draw card low range bet region 214, and three draw card bets predicting the identity of the draw card were also made. The first such bet predicted the draw card would be the “7 of clubs” by placing a chip 340 on the corresponding draw card identity bet region 222, the second such bet predicted the draw card would be the “9 of hearts” by placing a chip 342 on the appropriate draw card identity bet region 222, and the third such bet predicted the draw card would be the “King of hearts” by placing a chip 344 on the corresponding draw card identity bet region 222. In addition, one chaser bet, predicting that the draw card and the first two chaser cards will have a denomination of Jack, Queen, King or Ace, was made by placing a chip 346 on the three-card royal prediction region 226.

After all of the bets were received, the draw card 360 was drawn. In the exemplary round shown in FIG. 3B, the draw card is the “Queen of hearts”, and the various draw card bets are compared to the draw card. The draw card bet predicting the suit of the draw card as being “hearts” (chip 332), the draw card bet predicting the color of the draw card as “red” (chip 334) and the draw card bet predicting the denomination of the draw card as “Queen” (chip 336) are all correct, and the players who made those bets are credited accordingly. The draw card bet predicting that the denomination of the draw card will be in the “low” range of 2 through 7 (chip 338) and the draw card bets predicting the identity of the draw card (chips 340, 342 and 344) were incorrect, and the chips associated with those bets are forfeited to the House.

Since the draw card is a Queen and the chaser bet predicted that the draw card and the first two chaser cards would have a denomination of Jack, Queen, King or Ace, the identity of the draw card does not preclude the chaser bet from being correct. Therefore, after drawing the draw card 360, the chaser cards 362, 364, 366 are drawn. In this exemplary round, the chaser cards 362, 364, 366 are, in order, the “Jack of hearts”, the “Queen of diamonds” and the “6 of hearts”. Since the chaser bet (chip 346) predicted that the draw card and the first two chaser cards would have a denomination of Jack, Queen, King or Ace, the prediction of the chaser bet is correct, and the player who made the chaser bet will be credited accordingly.

In addition to an embodiment in which the cards are physically manipulated and drawing of the cards comprises physically drawing the cards from a physical plurality of cards, the methods described herein may also be implemented on any suitable computer or microprocessor-based system, such as a desktop or laptop computer or a mobile wireless telecommunication computing device, such as a smartphone or tablet computer, or via a computer network. For example, a computer-implemented representation of the exemplary playing surface 200 can be displayed on a screen, and players can make bets using a pointing device (which may be a finger if the screen is a touch screen).

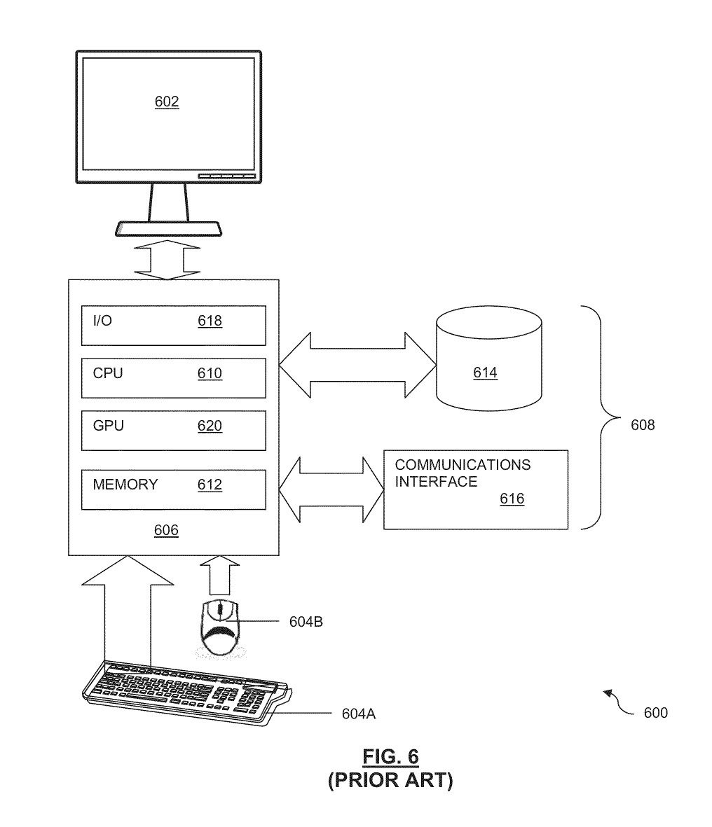

An illustrative computer system in respect of which the methods herein described may be implemented as a computer-simulated card game is presented as a block diagram in FIG. 6. The illustrative computer system is denoted generally by reference numeral 600 and includes a display 602, which may be a touchscreen display, input devices in the form of keyboard 604A and pointing device 604B, computer 606 and external devices 608. While pointing device 604B is depicted as a mouse, it will be appreciated that other types of pointing device may also be used.

The computer 606 may contain one or more processors or microprocessors, such as a central processing unit (CPU) 610. The CPU 610 performs arithmetic calculations and control functions to execute software stored in an internal memory 612, preferably random access memory (RAM) and/or read only memory (ROM), and possibly additional memory 614. The additional memory 614 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 614 may be physically internal to the computer 606, or external as shown in FIG. 6, or both.

The computer system 600 may also include other similar means for allowing computer programs or other instructions to be loaded. Such means can include, for example, a communications interface 616 which allows software and data to be transferred between the computer system 600 and external systems and networks. Examples of communications interface 616 can include a modem, a network interface such as an Ethernet card, a wireless communication interface, or a serial or parallel communications port. Software and data transferred via communications interface 616 are in the form of signals which can be electronic, acoustic, electromagnetic, optical or other signals capable of being received by communications interface 616. Multiple interfaces, of course, can be provided on a single computer system 600.

Input and output to and from the computer 606 is administered by the input/output (I/O) interface 618. This I/O interface 618 administers control of the display 602, keyboard 604A, external devices 608 and other such components of the computer system 600. The computer 606 also includes a graphical processing unit (GPU) 620. The latter may also be used for computational purposes as an adjunct to, or instead of, the (CPU) 610, for mathematical calculations.

The various components of the computer system 600 are coupled to one another either directly or by coupling to suitable buses.

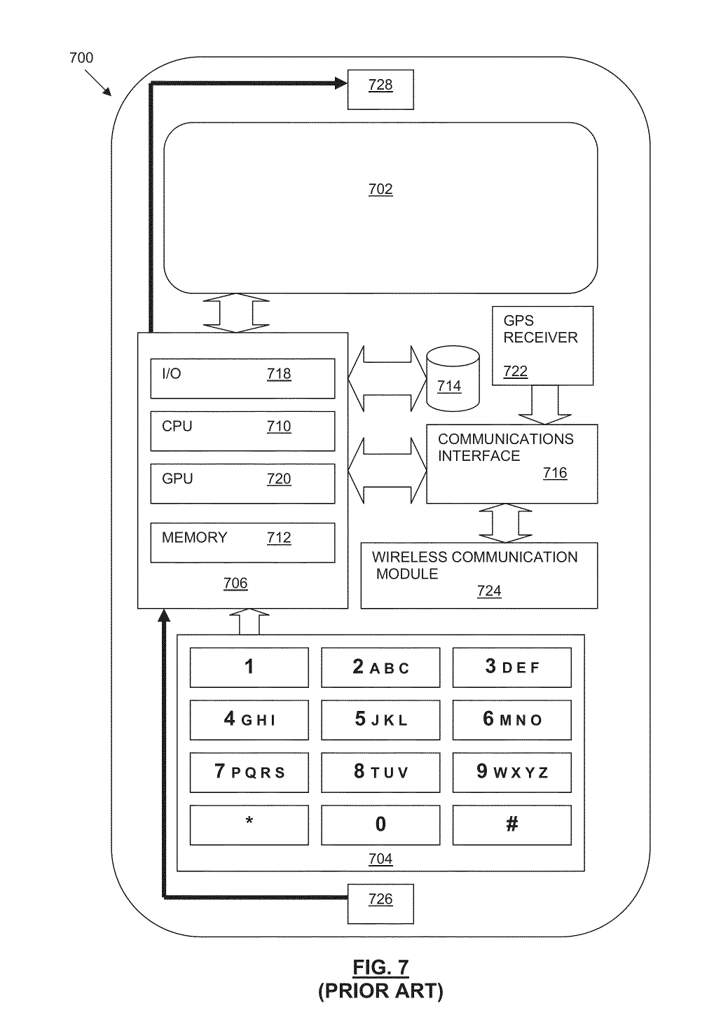

FIG. 7 shows an exemplary networked mobile wireless telecommunication computing device in the form of a smartphone 700, in respect of which the methods herein described may be implemented as a computer-simulated card game. The smartphone 700 includes a display 702, an input device in the form of keyboard 704 and an onboard computer system 706. The display 702 may be a touchscreen display and thereby serve as an additional input device or as an alternative to the keyboard 704. The onboard computer system 706 comprises a central processing unit (CPU) 710 having one or more processors or microprocessors for performing arithmetic calculations and control functions to execute software stored in an internal memory 712, preferably random access memory (RAM) and/or read only memory (ROM) and is coupled to additional memory 714 which will typically comprise flash memory, which may be integrated into the smartphone 700 or may comprise a removable flash card, or both. The smartphone 700 also includes a communications interface 716 which allows software and data to be transferred between the smartphone 700 and external systems and networks. The communications interface 716 is coupled to one or more wireless communication modules 724, which will typically comprise a wireless radio for connecting to one or more of a cellular network, a wireless digital network or a Wi-Fi network. The communications interface 716 will also typically enable a wired connection of the smartphone 700 to an external computer system. A microphone 726 and speaker 728 are coupled to the onboard computer system 706 to support the telephone functions managed by the onboard computer system 706, and GPS receiver hardware 722 may also be coupled to the communications interface 716 to support navigation operations by the onboard computer system 706. Input and output to and from the onboard computer system 706 is administered by the input/output (I/O) interface 718, which administers control of the display 702, keyboard 704, microphone 726 and speaker 728. The onboard computer system 706 may also include a separate graphical processing unit (GPU) 720. The various components are coupled to one another either directly or by coupling to suitable buses.

The methods described herein may be provided as computer program products comprising a tangible computer readable storage medium, such as non-volatile memory, having computer readable program code embodied therewith for executing the method. Thus, the non-volatile memory would contain instructions which, when executed by a processor, cause the computing device to execute the relevant method.

The a computer-implemented method for playing a card game as described herein may be implemented entirely in hardware, entirely in software, or by way of a combination of hardware and software. In a preferred embodiment, implementation is by way of software or a combination of hardware and software, which includes but is not limited to firmware, resident software, microcode, and the like. Furthermore, the above methods may be implemented in the form of a computer program product accessible from a computer usable or computer readable medium providing program code for use by or in connection with a computer or any instruction execution system. In such embodiments, the computer program product may reside on a computer usable or computer readable medium in a computer such as the memory 712 of the onboard computer system 706 of the smartphone 700 or the memory 612 of the computer 606, or on a computer usable or computer readable medium external to the onboard computer system 706 of the smartphone 700 or the computer 606, or on any combination thereof

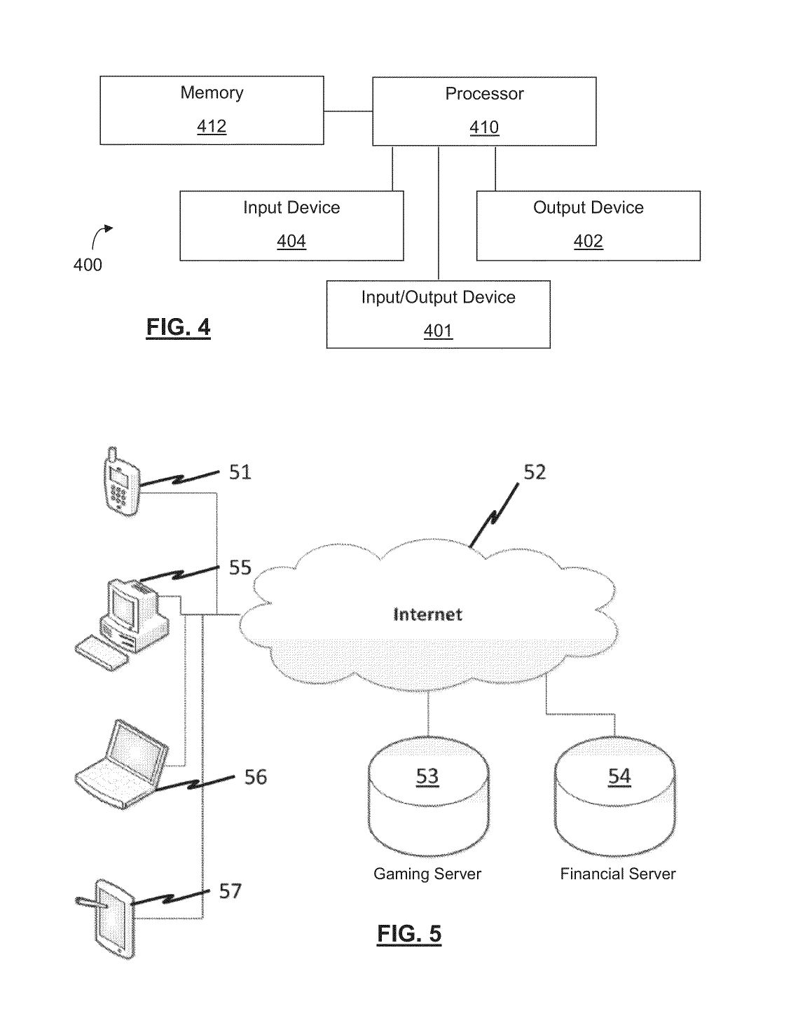

FIG. 4 shows a block diagram of certain components of an exemplary computer system 400, including a processor 410, an input/output device 401, output device 402, input device 404 and memory 412. The exemplary computer system shown in FIG. 4 may represent, for example, the computer system 600 or the smartphone 700. Thus, the processor 410 may be either the CPU 610 or 710, the input/output device may be a touchscreen display, the output device 402 may be the display 602 or 702, the input device 404 may be the keyboard 604A and/or pointing device 604B or the keyboard 702, and the memory 412 may be the memory 612 and/or 614, or the memory 712 and/or 714. The exemplary computer system shown in FIG. 4 implements a method of playing a card game with at least one player.

The processor 410 executes instructions stored in the memory 412 for simulating the provision of a plurality of cards, each card having a suit, denomination, and color. The processor 410 executes instructions for receiving at least one draw card bet from at least one of the at least one player, with each draw card bet predicting at least one of suit, denomination, color and card identity of a draw card. A player may, in response to a prompt generated by the processor 410 and presented via the input/output device 401 or the output device 43, use the input/output device 401 and/or the input device 404 in communication with the processor 410 to announce at least one bet on an outcome of a simulated drawing of the draw card from the plurality of cards. The processor 410 then executes instructions for receiving and storing the announced bet(s) in the memory 412. Optionally, the processor 410 may at this stage also execute instructions for receiving at least one chaser bet from at least one player. The magnitude of the bet(s) may be deducted from a player's account, which may also be stored in memory 412. The account may represent actual currency where legally permitted, or may represent a virtual currency, such as points.

After receiving the bet(s), the processor 410 executes instructions to simulate drawing of a first card from the plurality of simulated cards to obtain a simulated draw card. The simulated drawing may be purely random, simulating the selection of a card from a random position in a randomly shuffled deck, or may be quasi-random, for example simulating drawing the top card from a randomly shuffled deck (i.e. the shuffling is random but once the shuffling is complete the card order is predetermined according to the shuffled order). The processor executes instructions for communicating at least an indication of the simulated first drawn card, and may display the simulated card, or at least an indication thereof, on the input/output device 401 or the output device 43. The processor 410 also executes instructions to evaluate the at least one announced bet by comparing each draw card bet to the simulated draw card, and if the bet was accurate, executes instructions to compensate the player accordingly. The player may be compensated by adjusting the account stored in memory 412. Communicating at least an indication of the draw card may occur before, after or substantially simultaneously with evaluation of the draw card bet(s). Optionally, at this stage the processor 410 may execute instructions to prompt for, receive and store a chaser bet, either independent of the identity of the simulated draw card or only if the simulated draw card meets at least one predetermined criterion for availability of the chaser bet. The processor 410 then executes instructions to simulate random or quasi-random drawing of three additional cards from the simulated plurality of cards as chaser cards. The processor 410 also communicates at least an indication of the three additional simulated drawn cards, and may display these cards, or indications thereof, on the input/output device 401 or the output device 43. The processor 410 then executes instructions for evaluating the chaser bet(s) by comparing the chaser cards and the chaser bet(s); where the chaser bet includes a prediction of the draw card this may also include comparing the chaser bet(s) to the simulated draw card. Communicating at least an indication of the chaser cards may occur before, after or substantially simultaneously with evaluation of the chaser bet(s). The programming of suitable machine-readable instructions for simulating the provision of a plurality of playing cards, and for simulating the random or quasi-random drawing from that plurality of playing cards, is within the capability of one skilled in the art, now informed by the present disclosure.

In another embodiment shown in FIG. 5, the game may be played over a computer network such as the Internet 52. For example, the player(s) may communicate with a central gaming server 53 over the Internet 52 using computing devices 51, 55, 56, 57. The central gaming server 53 may be a single server or a collection of servers configured to operate the card game, and will execute instructions in a manner similar to that described above in respect of the computer system shown in FIG. 4. A player may connect to the central gaming server using, for example, a personal computer 55, laptop 56, tablet 57, mobile device, or mobile phone 51. Preferably, player(s) may connect to the same gaming session regardless of the device the player uses. The players may buy-in to the game using legal tender where legally permitted. For example, the central gaming server 53 may communicate with financial server 54 which contains financial information for a player. The player may send instructions to the central gaming server 53 to send instructions to the financial server 54 to obtain funds for the buy-in from an account managed by the financial server 54, such as a credit card account or bank account. In so doing, the player may also interact directly with the financial server 54 via the Internet 52, for example to verify his or her identity. The central gaming server 53 sends instructions to the player's personal computer 55, laptop 56, tablet 57, mobile device, or mobile phone 51 requiring the player(s) to announce at least one draw card bet and/or chaser bet. The central gaming server 53 executes instructions for simulating the provision of a plurality of cards, each card having a suit, denomination, and color, and executes instructions for simulating the random drawing of a first card from the simulated plurality of cards as the draw card, and for simulating the drawing of three additional cards as chaser cards. The color, suit, and denomination of the draw card and chaser cards may be transmitted from the central gaming server 53 to the player devices 51, 55, 56, 57 through the Internet 52. The central gaming server 53 then executes instructions for evaluating the draw card bet(s) and/or chaser bets and for compensating the player(s) according to predefined ratios where the bets were successful. The ratios may vary based on the number of player(s) in the same instance of a game. The central gaming server 53 may, either in response to player instructions or automatically according to predefined rules, send instructions to the financial server 54 to deposit the payout to the player's account.

In one embodiment, the player(s) may be allowed (or required) to announce a bet on another player's (or players') announced bet(s). For example Player A may be allowed to announce a bet on the successful outcome of Player B's announced bets. In another embodiment, Player A's ability to announce a bet on the success of Player B's announced bets is based on the number of bets Player B makes. For example, Player A may only be allowed to place a bet on the success of Player B's bets if Player B places 3 or more bets. In another embodiment, multiple players, within the same or different games, may pool their bets and bet on the outcome of Player C's bets.

In another embodiment, the player(s) may be allowed (or required) to announce a “progressive” bet. A progressive bet is a bet predicting a specific event (i.e., the drawing of a specific set of cards) where the progressive payout accumulates. The payout may accumulate over time and/or increase based on the magnitudes of some or all bets placed on a specific table, or on multiple tables. The progressive payout may reset to a predetermined level after the specific event occurs. In another embodiment, the progressive payout may reset after a player announces and wins a progressive bet. A player may be restricted on placing a progressive bet unless certain conditions are satisfied. For example, a player may only be permitted to announce a progressive bet after announcing three bets in a single round. In another example, a player may only be permitted to announce a progressive bet after announcing a bet or bets greater than a predetermined total bet magnitude.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof

What is claimed is:

1. A method of playing a card game with at least one player comprising:
receiving at least one draw card bet from at least one of the at least one player, each draw card bet predicting at least one of suit, denomination, color and card identity of a draw card;
physically drawing a first card from a plurality of cards as the draw card; and
evaluating each draw card bet by comparing each draw card bet to the draw card.

2. The method of claim 1, wherein predicting denomination of the draw card comprises predicting a denomination range of the draw card.

3. The method of claim 2, wherein predicting a denomination range of the draw card comprises predicting that the denomination of the draw card will fall within one of:
(a) a range between and including two and seven; and
(b) a range between and including nine and Ace.

4. The method of claim 1, further comprising:
receiving at least one chaser bet from at least one of the at least one player, each chaser bet predicting a denomination range for at least one of a set of chaser cards;
after drawing the first card from the plurality of cards as the draw card, physically drawing a set of cards from the plurality of cards as the chaser cards; and
evaluating each chaser bet by comparing each chaser bet to the chaser cards.

5. The method of claim 4, wherein the chaser bet is received before drawing the first card from the plurality of cards as the draw card.

6. The method of claim 5, wherein the chaser bet further predicts a denomination range for the draw card.

7. The method of claim 4, wherein the chaser bet is received only responsive to the draw card meeting at least one predetermined criterion for availability of the chaser bet.

8. The method of claim 4, wherein the chaser bet predicts that at least one of the chaser cards will have a denomination in the range Jack, Queen, King, Ace.

9. The method of claim 4, wherein evaluating each chaser bet by comparing each chaser bet to the chaser cards comprises considering the order in which the chaser cards were drawn.

10. The method of claim 4, wherein the set of cards comprises three cards.

11. The method of claim 1, further comprising the step of:
crediting the player who made that draw card bet, wherein the step of crediting is responsive to evaluating the draw card bet as successful.

12. A computer-implemented method of playing a card game with at least one player comprising:
executing, in a processor of a computer, instructions for receiving and storing at least one draw card bet from at least one of the at least one player, each draw card bet predicting at least one of suit, denomination, color and card identity of a draw card;
executing, in the processor of the computer, instructions for simulating drawing of a first card from a simulated plurality of cards to obtain a simulated first drawn card as the draw card;
executing, in the processor of the computer, instructions for evaluating the at least one draw card bet by comparing each draw card bet to the draw card; and
executing, in the processor of the computer, instructions for communicating at least an indication of the draw card.

13. The method of claim 12, wherein predicting denomination of the draw card comprises predicting a denomination range of the draw card.

14. The method of claim 13, wherein predicting a denomination range of the draw card comprises predicting that the denomination of the draw card will fall within one of:
(a) a range between and including two and seven; and
(b) a range between and including nine and Ace.

15. The method of claim 12, further comprising:
executing, in the processor of the computer, instructions for receiving and storing at least one chaser bet from at least one of the at least one player, each chaser bet predicting a denomination range for at least one of a set of chaser cards;
executing, in the processor of the computer, instructions for simulating drawing of a set of cards from the simulated plurality of cards as the chaser cards after simulating drawing of the first card from the simulated plurality of cards to obtain the simulated first drawn card as the draw card;
executing, in the processor of the computer, instructions for evaluating each chaser bet by comparing each chaser bet to the chaser cards; and
executing, in the processor of the computer, instructions for communicating at least an indication of the chaser cards.

16. The method of claim 15, wherein the instructions for receiving and storing at least one chaser bet from at least one of the at least one player are executed before executing the instructions for simulating drawing of the first card from the simulated plurality of cards to obtain the simulated first drawn card as the draw card.

17. The method of claim 16, wherein the chaser bet further predicts a denomination range for the draw card.

18. The method of claim 15, wherein the instructions for receiving and storing at least one chaser bet from at least one of the at least one player are executed only responsive to the draw card meeting at least one predetermined criterion for availability of the chaser bet.

19. The method of claim 15, wherein the chaser bet predicts that at least one of the chaser cards will have a denomination in the range Jack, Queen, King, Ace.

20. The method of claim 15, wherein the instructions for evaluating each chaser bet by comparing each chaser bet to the chaser cards comprise instructions for considering the order in which the chaser cards were drawn.

21. The method of claim 15, wherein the set of cards comprises three cards.

22. The method of claim 15, further comprising, responsive to evaluating the draw card bet as successful, executing, in the processor of the computer, instructions for crediting the player who made that draw card bet.

23. The method of claim 12, wherein the computer is selected from the group consisting of desktop computers, laptop computers, smartphones and tablet computers.

24. The method of claim 12, wherein:
the computer is a gaming server;
the at least one draw card bet is received from at least one computing device remote from and communicating with the gaming server; and
communicating at least an indication of the draw card comprises communicating with the at least one computing device.

25. The method of claim 24, wherein the at least one computing device comprises a computing device selected from the group consisting of desktop computers, laptop computers, smartphones and tablet computers.

26. The method of claim 24, wherein the gaming server and the at least one computing device communicate with one another over the Internet.

27. A data processing system for playing a simulated card game with at least one player, the data processing system comprising:
at least one processor;
a memory coupled to the at least one processor, the memory containing instructions which, when executed by the at least one processor, cause the data processing system to:
receive and store at least one draw card bet from at least one of the at least one player, each draw card bet predicting at least one of suit, denomination, color and card identity of a draw card;
simulate drawing of a first card from a simulated plurality of cards to obtain a simulated first drawn card as the draw card;
evaluate the at least one draw card bet by comparing each draw card bet to the draw card; and
communicate at least an indication of the draw card.

28. The data processing system of claim 27, wherein predicting denomination of the draw card comprises predicting a denomination range of the draw card.

29. The data processing system of claim 28, wherein predicting a denomination range of the draw card comprises predicting that the denomination of the draw card will fall within one of:
(a) a range between and including two and seven; and
(b) a range between and including nine and Ace.

30. The data processing system of claim 27, wherein the memory contains instructions which, when executed by the at least one processor, further cause the data processing system to:
receive and store at least one chaser bet from at least one of the at least one player, each chaser bet predicting a denomination range for at least one of a set of chaser cards;
simulate drawing of a set of cards from the simulated plurality of cards as the chaser cards after simulating drawing of the first card from the simulated plurality of cards to obtain the simulated first drawn card as the draw card;
evaluate each chaser bet by comparing each chaser bet to the chaser cards; and
communicate at least an indication of the chaser cards.

31. The data processing system of claim 30, wherein the memory contains instructions which, when executed by the at least one processor, cause the data processing system to receive the at least one chaser bet before simulating drawing of the first card from the simulated plurality of cards to obtain the simulated first drawn card as the draw card.

32. The data processing system of claim 31, wherein the chaser bet further predicts a denomination range for the draw card.

33. The data processing system of claim 30, wherein the memory contains instructions which, when executed by the at least one processor, cause the data processing system to receive the at least one chaser bet only responsive to the draw card meeting at least one predetermined criterion for availability of the chaser bet.

34. The data processing system of claim 30, wherein the chaser bet predicts that at least one of the chaser cards will have a denomination in the range Jack, Queen, King, Ace.

35. The data processing system of claim 30, wherein evaluating each chaser bet by comparing each chaser bet to the chaser cards comprises considering the order in which the chaser cards were drawn.

36. The data processing system of claim 30, wherein the set of cards comprises three cards.

37. The data processing system of claim 27, wherein the memory contains instructions which, when executed by the at least one processor, further cause the data processing system to, responsive to evaluating the draw card bet as successful, credit the player who made that draw card bet.

38. The data processing system of claim 27, wherein the memory contains instructions which, when executed by the at least one processor, cause the data processing system to communicate at least an indication of the draw card by displaying an image of the draw card on a display of the data processing system.

39. The data processing system of claim 27, wherein the data processing system is one of a desktop computer, a laptop computer, a smartphone and a tablet computer.

40. The data processing system of claim 27, wherein:
the data processing system is a gaming server;
the at least one draw card bet is received from at least one computing device remote from and communicating with the gaming server; and
communicating at least an indication of the draw card comprises communicating with the at least one computing device.

41. The data processing system of claim 27, wherein the at least one computing device comprises a computing device selected from the group consisting of desktop computers, laptop computers, smartphones and tablet computers.
